(19) United States
(12) Patent Application Publication
(10) Pub. No.: US 2025/0200343 A1
(43) Pub. Date: Jun. 19, 2025

(54) NEURAL NETWORKS WITH PIECEWISE LINEAR ACTIVATION FUNCTIONS

(71) Applicant: Google LLC, Mountain View, CA (US)

(72) Inventors: Ehsan Amid, Mountain View, CA (US); Jared Alexander Lichtarge, Brooklyn, NY (US)

(21) Appl. No.: 18/981,337

(22) Filed: Dec. 13, 2024

Related U.S. Application Data
(60) Provisional application No. 63/609,832, filed on Dec. 13, 2023.

(51) Int. Cl. G06N 3/048; G06N 3/09

(52) U.S. Cl. CPC G06N 3/048; G06N 3/09

(57) ABSTRACT

Methods, systems, and apparatus, including computer programs encoded on computer storage media, for processing inputs using neural networks. In some examples, the neural network has one or more layers that each have a respective piecewise-linear activation function. In some examples, the neural network is trained with a learned link function.

### CROSS-REFERENCE TO RELATED APPLICATION

This application claims priority to U.S. Provisional Application No. 63/609,832, filed on Dec. 13, 2023. The disclosure of the prior application is considered part of and is incorporated by reference in the disclosure of this application.

### BACKGROUND

This specification relates to processing inputs using neural networks.

Neural networks are machine learning models that employ one or more layers of nonlinear units to predict an output for a received input. Some neural networks include one or more hidden layers in addition to an output layer. The output of each hidden layer is used as input to the next layer in the network, i.e., the next hidden layer or the output layer. Each layer of the network generates an output from a received input in accordance with current value inputs of a respective set of parameters.

### SUMMARY

This specification describes a system implemented as computer programs on one or more computers in one or more locations that process network inputs using a neural network. More specifically, in some cases, at least one of the layers of the neural network has an activation function that is a piecewise linear activation function. The piecewise linear activation function, in turn, has one or more parameters that have been learned during the training of the neural network. In addition or in the alternative, a training system can train the neural network using a learned link function.

The subject matter described in this specification can be implemented in particular embodiments so as to realize one or more of the following advantages.

Modern neural networks generally have a large number of parameters that are learned during training. However, these neural networks also have certain operations that are fixed and not customizable to any given task, potentially limiting the degree to which the neural network can be optimized to perform well on a particular machine learning task. As a particular example, modern neural networks generally have activation functions that perform operations that are fixed prior to training and not adjusted during the training. As another example, modern neural networks generally make use of loss functions that are established at the beginning of training and held fixed or adjusted using a pre-determined schedule during training.

This specification, on the other hand, describes neural networks that (i) have learnable activation functions, (ii) that are trained using a learned final loss, or (iii) both. Thus, the described neural networks can be trained “end-to-end” for a given task, allowing them to achieve a higher-degree of customization for the given task, thereby causing the trained neural network to achieve better performance on the given task once trained.

Moreover, by employing (i), (ii), or (iii), the neural network can converge more quickly during training, making training more computationally efficient. That is, performing training iterations is computationally expensive, requiring a significant number of accelerator cycles and memory, particularly for modern neural networks with large numbers of parameters. By achieving quicker convergence due to the higher degree of customizability, the described techniques require fewer training iterations, improving the computational efficiency of the training process.

More specifically, by representing the learned activation function as a learned piecewise linear function, the described techniques ensure that the learned activation functions are computationally-efficient while being flexible enough to approximate any arbitrary continuous function. That is, the learned piecewise linear activation functions can be computed in a computationally-efficient manner, e.g., by representing them using a sum of ReLU functions. Thus, the learned activation function can replace a pre-configured activation function with minimal to no additional computational overhead while offering significant improvements during and after training.

Additionally, for the same reasons, by implementing the learned loss using link functions that are represented as learned piecewise linear functions, the described techniques ensure that the learned loss can replace a pre-configured loss with minimal to no additional computational overhead while offering significant improvements during and after training.

The details of one or more embodiments of the subject matter of this specification are set forth in the accompanying drawings and the description below.

Other features, aspects, and advantages of the subject matter will become apparent from the description, the drawings, and the claims.

### BRIEF DESCRIPTION OF THE DRAWINGS

FIG. 1 shows an example training system and an example inference system.

FIG. 2 is a flow diagram of an example process for processing a network input to generate a network output.

FIG. 3 shows an example of the operation of a piecewise-linear activation function.

FIG. 4 is a flow diagram of an example process for training a neural network with a learned link function.

Like reference numbers and designations in the various drawings indicate like elements.

### DETAILED DESCRIPTION

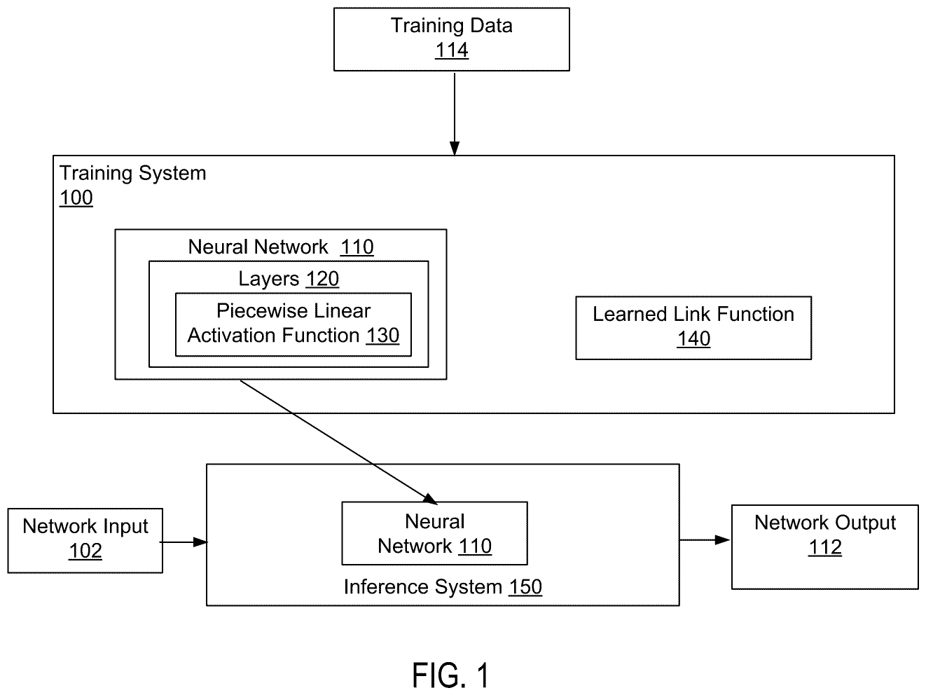

FIG. 1 shows an example training system 100 and an example inference system 150.

The training system 100 and the inference system 150 are examples of systems implemented as computer programs on one or more computers in one or more locations, in which the systems, components, and techniques described below can be implemented. The system 100 and the system 150 can be implemented on the same set of one or more computers or on different sets of one or more computers in different locations.

The system 100 trains a neural network 110 on training data 114 to perform a machine learning task.

After the training, the inference system 150 uses the neural network 110 to perform the machine learning task, i.e., to receive new network inputs 102 and to process the new network inputs 102 to generate a network output 112 for the task for each of the network inputs 102.

The neural network 110 can be trained to perform any kind of machine learning task, i.e., can be configured to receive any kind of digital data input and to generate any kind of score, classification, or regression output based on the input.

In some cases, the neural network 110 is a neural network that is configured to perform an image processing task, i.e., receive an input image and to process the input image to generate a network output for the input image. For example, the task may be image classification and the output generated by the neural network for a given image may be scores for each of a set of object categories (categories are also referred to as “classes”), with each score representing an estimated likelihood that the image contains an image of an object belonging to the category. As another example, the task can be image embedding generation and the output generated by the neural network can be a numeric embedding of the input image. As yet another example, the task can be object detection and the output generated by the neural network can identify locations in the input image at which particular types of objects are depicted. As yet another example, the task can be image segmentation and the output generated by the neural network can assign each pixel of the input image to a category from a set of categories.

As another example, if the inputs to the neural network 110 are Internet resources (e.g., web pages), documents, or portions of documents or features extracted from Internet resources, documents, or portions of documents, the task can be to classify the resource or document, i.e., the output generated by the neural network for a given Internet resource, document, or portion of a document may be a score for each of a set of topics, with each score representing an estimated likelihood that the Internet resource, document, or document portion is about the topic.

As another example, if the inputs to the neural network 110 are features of an impression context for a particular advertisement, the output generated by the neural network may be a score that represents an estimated likelihood that the particular advertisement will be clicked on.

As another example, if the inputs to the neural network 110 are features of a personalized recommendation for a user, e.g., features characterizing the context for the recommendation, e.g., features characterizing previous actions taken by the user, the output generated by the neural network may be a score for each of a set of content items, with each score representing an estimated likelihood that the user will respond favorably to being recommended the content item.

As another example, if the input to the neural network 110 is a sequence of text in one language, the output generated by the neural network may be a score for each of a set of pieces of text in another language, with each score representing an estimated likelihood that the piece of text in the other language is a proper translation of the input text into the other language.

As another example, the task may be an audio processing task. For example, if the input to the neural network 110 is a sequence representing a spoken utterance, the output generated by the neural network may a piece of text that is a transcript for the utterance. As another example, the task may be a keyword spotting task where, if the input to the neural network 110 is a sequence representing a spoken utterance, the output generated by the neural network can indicate whether a particular word or phrase (“hotword”) was spoken in the utterance. As another example, if the input to the neural network 110 is a sequence representing a spoken utterance, the output generated by the neural network can identify the natural language in which the utterance was spoken.

As another example, the task can be a natural language processing or understanding task, e.g., an entailment task, a paraphrase task, a textual similarity task, a sentiment task, a sentence completion task, a grammaticality task, and so on, that operates on a sequence of text in some natural language.

As another example, the task can be a text generation task, where the input is a sequence of text, and the output is another sequence of text, e.g., a completion of the input sequence of text, a response to a question posed in the input sequence, or a sequence of text that is about a topic specified by the first sequence of text. As another example, the input to the text generation task can be an input other than text, e.g., an image, and the output sequence can be text that describes the input.

As another example, the task can be a computer code generation task, where the input is a sequence of text, e.g., computer code or natural language text or a mix of both, and the output is a sequence of computer code, e.g., a completion of the input sequence of text, a response to a question posed in the input sequence, or a sequence of code that carries out a task specified by the first sequence of text.

As another example, the task can be a text to speech task, where the input is text in a natural language or features of text in a natural language and the network output is a spectrogram or other data defining audio of the text being spoken in the natural language.

As another example, the task can be a health prediction task, where the input is electronic health record data for a patient and the output is a prediction that is relevant to the future health of the patient, e.g., a predicted treatment that should be prescribed to the patient, the likelihood that an adverse health event will occur to the patient, or a predicted diagnosis for the patient.

As another example, the task can be an agent control task, where the input is an observation characterizing the state of an environment and the output defines an action to be performed by the agent in response to the observation. The agent can be, e.g., a real-world or simulated robot, a control system for an industrial facility, or a control system that controls a different kind of agent.

The neural network 110 can have any appropriate architecture that allows the neural network to perform the particular machine learning task, i.e., to map network inputs 102 of the type and dimensions required by the task to network outputs 112 of the type and dimensions required by the task.

That is, when the task is a classification task, the neural network 110 maps the input to the classification task to a set of scores, one for each possible class for the task. When the task is a regression task, the neural network 110 maps the input to the regression task to a set of regressed values, one for each value that needs to be generated in order to perform the regression task.

As one example, when the inputs are images, the neural network 110 can be a convolutional neural network, e.g., a neural network having a ResNet architecture, an Inception architecture, an EfficientNet architecture, and so on, or a Transformer neural network, e.g., a vision Transformer.

As another example, when the inputs are text, features of medical records, audio data or other sequential data, the neural network 110 can be a recurrent neural network, e.g., a long short-term memory (LSTM) or gated recurrent unit (GRU) based neural network, or a Transformer neural network.

As another example, the neural network 110 can be a feed-forward neural network, e.g., an MLP, that includes multiple fully-connected layers.

Generally, however, the neural network 110 includes multiple layers 120 that each have respective weights.

In particular, each of the multiple layers 120 is configured to receive a layer input and apply the respective weights for the layer to the layer input to generate a pre-activation for the layer. How the layer applies the weights to the layer input depends on the type of neural network layer. For example, a convolutional layer computes a convolution between the weights and the layer input. As another example, a fully-connected layer computes a product between the weights of the layer and the layer input. Optionally, the layer can also add or subtract a bias from the output of the linear transformation to generate the pre-activation.

Each of the multiple layers 120 is then configured to apply an activation function of the layer to the pre-activation to generate a post-activation, i.e., the layer output of the layer, and then provide the post-activation to one or more other layers of the neural network 110 that are configured to receive input from the layer according to the neural network architecture.

The neural network 110 can then include one or more output layers that process the outputs of one or more of the earlier layers 120 in the neural network 110 to generate the network output 112. The output layer(s) can generally be of any appropriate type that maps the output(s) of the earlier layer(s) 120 to the classification or regression output required for the machine learning task. Examples of output layers include fully-connected layers, softmax layers, and so on.

The activation function of any given layer 120 is an element-wise non-linear function, and different layers can have different activation functions.

The activation function is referred to as “element-wise” because the function operates on each element of the pre-activation for the layer independently, i.e., applies the same operations to each element of the pre-activation to generate the corresponding element of the post-activation.

Examples of activation functions include ReLU, GELU, Swish, Leaky ReLU, Tanh, and Arc Tan. Another example of an activation function is the identity function, i.e., for a linear layer that does not apply a non-linear transform.

In some implementations, the respective activation function for at least one of the layers is a piecewise linear activation function 130 that has one or more parameters that have been learned during the training of the neural network 110 on the machine learning task by the training system 100.

A piecewise linear function is a function whose domain is partitioned into multiple subdomains on which the function may be defined differently but is a linear function for all of the domains.

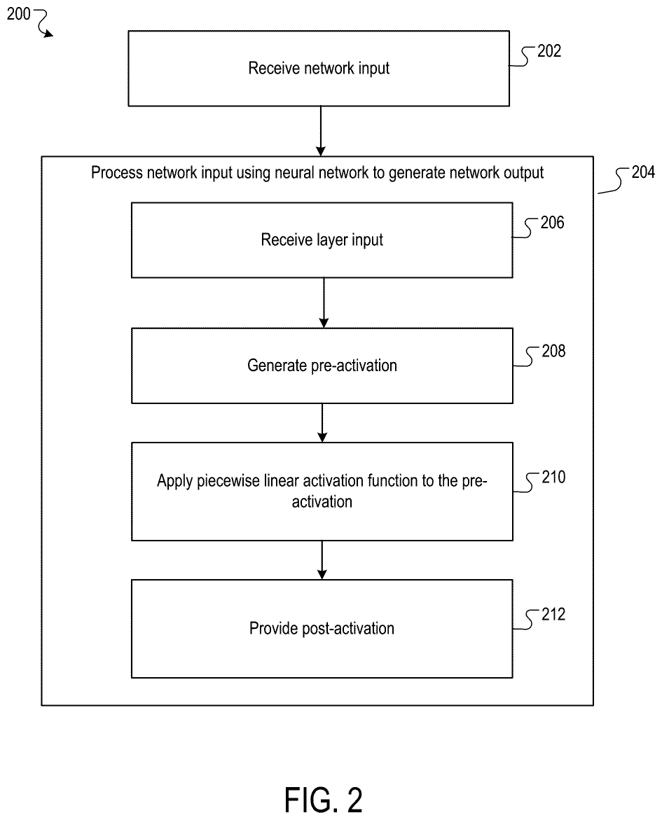

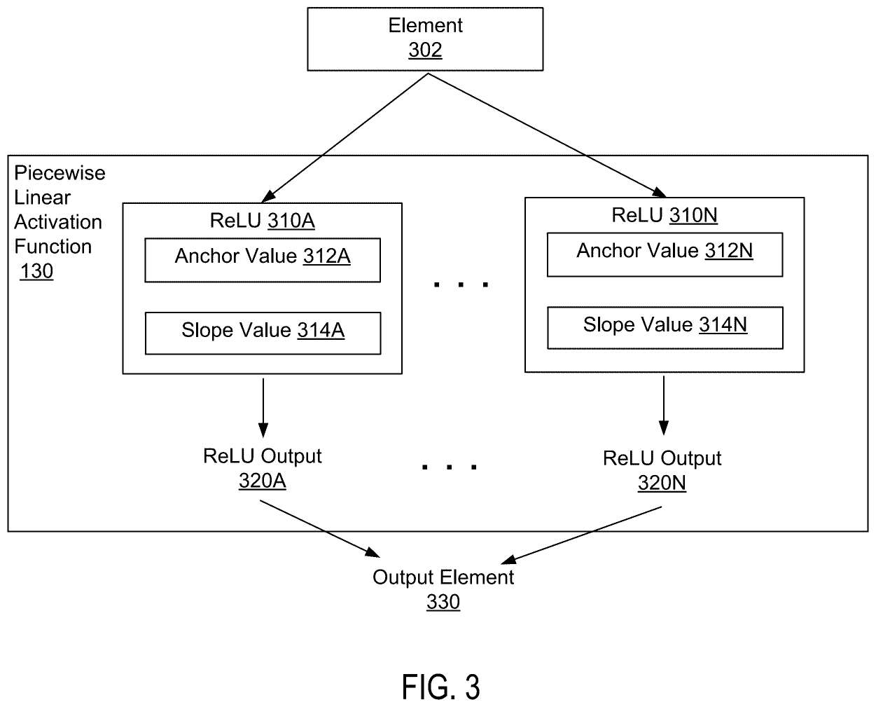

Piecewise linear activation functions are described in more detail below with reference to FIGS. 2 and 3.

When training the neural network 110, the system 100 trains the neural network 110 on multiple training batches selected from the training data 114.

Each training batch includes one or more training inputs and a respective label for each training input.

Generally, to train the neural network 110 on a given batch, the system 100 determines a gradient with respect to the network parameters of an objective function for the training using the given batch and then applies an optimizer, e.g., stochastic gradient descent, Adam, or Adafactor, to the gradient to update the values of the network parameters of the neural network, i.e., the weights and, optionally, biases of the layers 120 and the output layer(s) of the neural network 110.

When the neural network 110 includes one or more piecewise linear activation functions 130, the training includes updating the values of the one or more parameters of each of the piecewise linear activation functions 130.

Moreover, in some implementations, when the task is a multi-class classification task, as part of the training, the system 100 determines gradients for the training inputs in the batch using a learned link function 140 that maps logit vectors to link vectors that are used to compute the gradient with respect to the network parameters. The link function 140 is referred to as “learned” because the link function has one or more parameters that are learned during the training of the neural network 110. Thus, the system 100 can update the learned link function 140 during the training of the neural network, i.e., by updating the parameters of the learned link function 140.

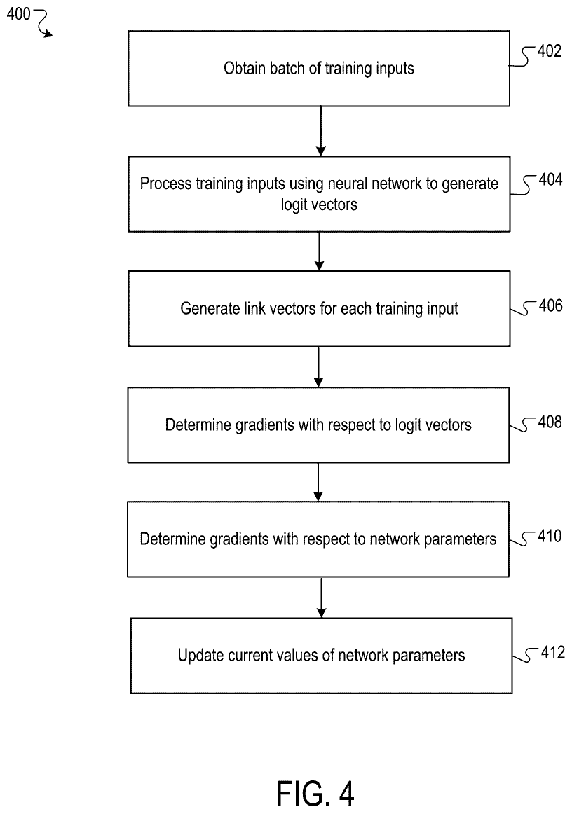

Training the neural network 110 with a learned link function is described in more detail below with reference to FIG. 4.

FIG. 2 is a flow diagram of an example process 200 for processing a network input using a neural network. For convenience, the process 200 will be described as being performed by a system of one or more computers located in one or more locations. For example, an inference system, e.g., the inference system 150 depicted in FIG. 1, appropriately programmed in accordance with this specification, can perform the process 200.

The system receives a network input (step 202).

The system processes the network input using a neural network to generate an output for the network input for a machine learning task (step 204).

As described above, the neural network includes multiple layers that each have respective weights.

In particular, each of the multiple layers is configured to receive a layer input and apply the respective weights for the layer to the layer input to generate a pre-activation for the layer.

Each of the multiple layers is then configured to apply an activation function of the layer to the pre-activation to generate a post-activation, i.e., the layer output of the layer, and then provide the post-activation to one or more other layers of the neural network that are configured to receive input from the layer according to the neural network architecture.

The activation function of any given layer is an element-wise non-linear function, and different layers can have different activation functions.

Generally, and as will be described in more detail below, the respective activation function for at least one of the layers is a piecewise linear activation function that has one or more parameters that have been learned during training of the neural network on the machine learning task.

Thus, as part of processing the network input using the neural network and for each layer that has a piecewise linear activation function, the system receives a layer input for the layer (step 206). For example, the layer input can be the output of the preceding layer in the neural network or, for the first layer of the neural network, the network input.

The system applies the respective weights for the layer to the layer input to generate a pre-activation for the layer (step 208).

The system applies the piecewise linear activation function for the layer to the pre-activation for the layer to generate a post-activation, i.e., the layer output of the layer (step 210). For example, the piecewise linear activation can be a sum of rectified linear unit (ReLU) functions, with each ReLU function having a respective anchor value and a respective slope value. That is, each ReLU function can be a function of the form:

$$f ( x ) = {[ x - {x}_{i} ]}_{+} \cdot {s}_{i} ,$$

where x is a given element of the layer input, xᵢ is the anchor value of the function and sᵢ is the slope value of the function, and [x−xᵢ]+=max(x−xᵢ,0).

Thus, the piecewise linear activation function ƒ̅(x) can be expressed as:

$$\overline{f} ( x ) = {\sum }_{i ∈ [ n ]} {[ x - {x}_{i} ]}_{+} \cdot {s}_{i} ,$$

where [n]={1, . . . n} and n is the total number of ReLU functions that make up the piecewise linear activation function.

In this example, for each ReLU function, the respective anchor values and slope values have been learned during the training of the neural network on the machine learning task. That is, because the piecewise linear activation function ƒ̅(x) is differentiable with respect to both the anchor values and the slope values, the anchor values and the slope values can be learned through gradient descent updates during the training. That is, during the training, gradients of the objective function for the training with respect to the anchor values and the slope values can be determined through backpropagation (due to the piecewise linear activation function being differentiable) and then an optimizer, e.g., stochastic gradient descent, Adam, Adafactor, or another appropriate optimizer, can be applied to the gradients to update the anchor values and the slope values.

Prior to the training, the respective anchor values and the respective slope values are initialized. In some cases, the values can be initialized to random values.

In some other cases, however, the values can be initialized using a reference activation function.

For example, to initialize the respective anchor values and the respective slope values, the system can perform a least-squares minimization to identify the respective anchor values and the respective slope values that minimize an error between outputs of the piecewise linear activation function and the reference activation function for a set of evaluation points. For example, these values can be determined by performing a least-squares minimization to identify the respective anchor values and the respective slope values that minimize the error between outputs of the piecewise linear activation function and the reference activation function for the set of evaluation points. For example, when an existing neural network architecture is being modified to replace an existing activation function with a piecewise linear activation function, the reference activation function can be the existing activation function that is being replaced with the piecewise linear activation function. As a particular example, the reference activation function can be a ReLU function.

The system then provides the post-activation to one or more other layers of the neural network that are configured to receive input from the layer according to the neural network architecture (step 212).

FIG. 3 shows an example 300 of the operations performed by a piece-wise linear activation function 130 for a given element 302 of a pre-activation.

In the example of FIG. 3, the piece-wise linear activation function 130 is a sum of n ReLUs 310.

Each of the ReLUs 310 has a respective anchor value 312 and a respective slope value 314. As described above, the anchor values 312 and the slope values 314 can have been learned during the training of the neural network.

The piece-wise linear activation function applies each of the ReLUs 310 to the element 302 to generate a ReLU output 320. That is, for each ReLU 310, the activation function determines the difference between the element 302 and the respective anchor value 312. If the difference is less than or equal to zero, the piece-wise linear activation function sets the ReLU output 320 to zero. If the difference is greater than zero, the piece-wise linear activation function determines the ReLU output 320 to be the product of the slope value 314 and the difference.

The piece-wise linear activation function then sums the ReLU output 320 to generate the corresponding output element 330, i.e., the corresponding element of the post-activation.

FIG. 4 is a flow diagram of an example process 400 for training a neural network with a learned link function. For convenience, the process 400 will be described as being performed by a system of one or more computers located in one or more locations. For example, a training system, e.g., the training system 100 depicted in FIG. 1, appropriately programmed in accordance with this specification, can perform the process 400.

The system can repeatedly perform the process 400 on different batches of training data in order to train the neural network.

The system obtains a batch that includes one or more training inputs and a respective label for each training input (step 402).

The system then performs steps 404-410 for each training input in the batch.

The system processes the training input using the neural network and in accordance with current values of the network parameters to generate a respective logit vector for the training input (step 404).

The system generates a link vector that includes a respective score for each class (step 406).

As part of generating the link vector, for each class, the system applies a constrained learned link function for the class to the respective logit for the class in the respective logit vector for the training input.

The link function is referred to as “learned” because the link function has parameters that are learned jointly with the network parameters during the training of the neural network. The link function is referred to as “constrained” because the image of the link function is constrained to a fixed interval, e.g., [0,1]. In other words, the link function spans the fixed interval, e.g., [0,1].

For example, the constrained learned link function for a given class can be a piecewise linear function that is a sum of a plurality of activation functions each having one or more parameters, i.e., one or more parameters that are adjusted to update the constrained learned link function during the training of the neural network.

For example, the constrained learned link function for each class can be a sum of ReLu functions, as described above.

As another example, the constrained learned link function for each class can be a sum of reverse-ReLU functions.

Each reverse-ReLU function has a respective anchor value and a respective slope value, with the respective anchor values and the respective slope values being learned during the training of the neural network.

In other words, the reverse-ReLU function g (z) for the j-th class can be expressed as:

$${\overline{g}}_{j} ( z ) = {[ 1 - {\sum }_{i ∈ [ n ]} {[ {z}_{ji} - z ]}_{+} \cdot {sj}_{i} ]}_{+} .$$

where z is the logit for the j-th class, sⱼᵢ is the slope value of i-th reverse-ReLU function and zⱼᵢ is the anchor value of i-th reverse-ReLU function.

After applying the constrained learned link function for each class for each class to generate a respective adjusted logit for each class, the system can then map each of the respective adjusted logits to probabilities to generate the link vector. For example, the system can apply a softmax function to the adjusted logits to generate the probabilities.

The system determines, using the link vector and the label, a gradient with respect to the respective logit vector (step 408).

In particular, the gradient is a gradient of a loss function for the training of the neural network. Generally, the gradient with respect to the logit vector depends on the link vector and the label.

For example, the gradient of a composite proper loss between the label and the output logits is equal to the link vector minus the label vector.

The system determines, from the gradient with respect to the respective logit vector, a gradient with respect to the network parameters through backpropagation (step 410). That is, the system backpropagates the gradient with respect to the respective logit vector to determine a gradient with respect to the network parameters of the loss function for the training.

The system then updates the current values of the network parameters using the gradients with respect to the network parameters for the training inputs in the batch (step 412).

For example, the system can determine a combined gradient with respect to the network parameters by combining, e.g., averaging or summing, the gradients for the training inputs and then apply an optimizer, e.g., stochastic gradient descent, Adam, Adafactor, or another appropriate optimizer, to the combined gradient to update the current values of the network parameters.

The system can then also update the constrained learned link function. In particular, the system can update the constrained learned link function using, for each training input in the batch, the link vector for the training input and the label for the training input. For example, the system can determine a gradient of the loss with respect to the parameters of link functions for the classes and then apply an optimizer, e.g., stochastic gradient descent, Adam, Adafactor, or another appropriate optimizer, to the gradient to update the parameters. In some cases, the system can apply clipping to the resulting updated parameters to ensure that the updated parameters do not cause the function for any given class to fall outside of the constraint.

This specification uses the term “configured” in connection with systems and computer program components. For a system of one or more computers to be configured to perform particular operations or actions means that the system has installed on it software, firmware, hardware, or a combination of them that in operation cause the system to perform the operations or actions. For one or more computer programs to be configured to perform particular operations or actions means that the one or more programs include instructions that, when executed by data processing apparatus, cause the apparatus to perform the operations or actions.

Embodiments of the subject matter and the functional operations described in this specification can be implemented in digital electronic circuitry, in tangibly-embodied computer software or firmware, in computer hardware, including the structures disclosed in this specification and their structural equivalents, or in combinations of one or more of them. Embodiments of the subject matter described in this specification can be implemented as one or more computer programs, e.g., one or more modules of computer program instructions encoded on a tangible non transitory storage medium for execution by, or to control the operation of, data processing apparatus. The computer storage medium can be a machine-readable storage device, a machine-readable storage substrate, a random or serial access memory device, or a combination of one or more of them. Alternatively or in addition, the program instructions can be encoded on an artificially generated propagated signal, e.g., a machine-generated electrical, optical, or electromagnetic signal, that is generated to encode information for transmission to suitable receiver apparatus for execution by a data processing apparatus.

The term “data processing apparatus” refers to data processing hardware and encompasses all kinds of apparatus, devices, and machines for processing data, including by way of example a programmable processor, a computer, or multiple processors or computers. The apparatus can also be, or further include, special purpose logic circuitry, e.g., an FPGA (field programmable gate array) or an ASIC (application specific integrated circuit). The apparatus can optionally include, in addition to hardware, code that creates an execution environment for computer programs, e.g., code that constitutes processor firmware, a protocol stack, a database management system, an operating system, or a combination of one or more of them.

A computer program, which may also be referred to or described as a program, software, a software application, an app, a module, a software module, a script, or code, can be written in any form of programming language, including compiled or interpreted languages, or declarative or procedural languages; and it can be deployed in any form, including as a stand alone program or as a module, component, subroutine, or other unit suitable for use in a computing environment. A program may, but need not, correspond to a file in a file system. A program can be stored in a portion of a file that holds other programs or data, e.g., one or more scripts stored in a markup language document, in a single file dedicated to the program in question, or in multiple coordinated files, e.g., files that store one or more modules, sub programs, or portions of code. A computer program can be deployed to be executed on one computer or on multiple computers that are located at one site or distributed across multiple sites and interconnected by a data communication network.

In this specification, the term “database” is used broadly to refer to any collection of data: the data does not need to be structured in any particular way, or structured at all, and it can be stored on storage devices in one or more locations. Thus, for example, the index database can include multiple collections of data, each of which may be organized and accessed differently.

Similarly, in this specification the term “engine” is used broadly to refer to a software-based system, subsystem, or process that is programmed to perform one or more specific functions. Generally, an engine will be implemented as one or more software modules or components, installed on one or more computers in one or more locations. In some cases, one or more computers will be dedicated to a particular engine; in other cases, multiple engines can be installed and running on the same computer or computers.

The processes and logic flows described in this specification can be performed by one or more programmable computers executing one or more computer programs to perform functions by operating on input data and generating output. The processes and logic flows can also be performed by special purpose logic circuitry, e.g., an FPGA or an ASIC, or by a combination of special purpose logic circuitry and one or more programmed computers.

Computers suitable for the execution of a computer program can be based on general or special purpose microprocessors or both, or any other kind of central processing unit. Generally, a central processing unit will receive instructions and data from a read only memory or a random access memory or both. The essential elements of a computer are a central processing unit for performing or executing instructions and one or more memory devices for storing instructions and data. The central processing unit and the memory can be supplemented by, or incorporated in, special purpose logic circuitry. Generally, a computer will also include, or be operatively coupled to receive data from or transfer data to, or both, one or more mass storage devices for storing data, e.g., magnetic, magneto optical disks, or optical disks. However, a computer need not have such devices. Moreover, a computer can be embedded in another device, e.g., a mobile telephone, a personal digital assistant (PDA), a mobile audio or video player, a game console, a Global Positioning System (GPS) receiver, or a portable storage device, e.g., a universal serial bus (USB) flash drive, to name just a few.

Computer readable media suitable for storing computer program instructions and data include all forms of non volatile memory, media and memory devices, including by way of example semiconductor memory devices, e.g., EPROM, EEPROM, and flash memory devices; magnetic disks, e.g., internal hard disks or removable disks; magneto optical disks; and CD ROM and DVD-ROM disks.

To provide for interaction with a user, embodiments of the subject matter described in this specification can be implemented on a computer having a display device, e.g., a CRT (cathode ray tube) or LCD (liquid crystal display) monitor, for displaying information to the user and a keyboard and a pointing device, e.g., a mouse or a trackball, by which the user can provide input to the computer. Other kinds of devices can be used to provide for interaction with a user as well; for example, feedback provided to the user can be any form of sensory feedback, e.g., visual feedback, auditory feedback, or tactile feedback; and input from the user can be received in any form, including acoustic, speech, or tactile input. In addition, a computer can interact with a user by sending documents to and receiving documents from a device that is used by the user; for example, by sending web pages to a web browser on a user's device in response to requests received from the web browser. Also, a computer can interact with a user by sending text messages or other forms of message to a personal device, e.g., a smartphone that is running a messaging application, and receiving responsive messages from the user in return.

Data processing apparatus for implementing machine learning models can also include, for example, special-purpose hardware accelerator units for processing common and compute-intensive parts of machine learning training or production, e.g., inference, workloads.

Machine learning models can be implemented and deployed using a machine learning framework, e.g., a TensorFlow framework or a Jax framework.

Embodiments of the subject matter described in this specification can be implemented in a computing system that includes a back end component, e.g., as a data server, or that includes a middleware component, e.g., an application server, or that includes a front end component, e.g., a client computer having a graphical user interface, a web browser, or an app through which a user can interact with an implementation of the subject matter described in this specification, or any combination of one or more such back end, middleware, or front end components. The components of the system can be interconnected by any form or medium of digital data communication, e.g., a communication network. Examples of communication networks include a local area network (LAN) and a wide area network (WAN), e.g., the Internet.

The computing system can include clients and servers. A client and server are generally remote from each other and typically interact through a communication network. The relationship of client and server arises by virtue of computer programs running on the respective computers and having a client-server relationship to each other. In some embodiments, a server transmits data, e.g., an HTML page, to a user device, e.g., for purposes of displaying data to and receiving user input from a user interacting with the device, which acts as a client. Data generated at the user device, e.g., a result of the user interaction, can be received at the server from the device.

While this specification contains many specific implementation details, these should not be construed as limitations on the scope of any invention or on the scope of what may be claimed, but rather as descriptions of features that may be specific to particular embodiments of particular inventions. Certain features that are described in this specification in the context of separate embodiments can also be implemented in combination in a single embodiment. Conversely, various features that are described in the context of a single embodiment can also be implemented in multiple embodiments separately or in any suitable subcombination. Moreover, although features may be described above as acting in certain combinations and even initially be claimed as such, one or more features from a claimed combination can in some cases be excised from the combination, and the claimed combination may be directed to a subcombination or variation of a subcombination.

Similarly, while operations are depicted in the drawings and recited in the claims in a particular order, this should not be understood as requiring that such operations be performed in the particular order shown or in sequential order, or that all illustrated operations be performed, to achieve desirable results. In certain circumstances, multitasking and parallel processing may be advantageous. Moreover, the separation of various system modules and components in the embodiments described above should not be understood as requiring such separation in all embodiments, and it should be understood that the described program components and systems can generally be integrated together in a single software product or packaged into multiple software products.

Particular embodiments of the subject matter have been described. Other embodiments are within the scope of the following claims. For example, the actions recited in the claims can be performed in a different order and still achieve desirable results. As one example, the processes depicted in the accompanying figures do not necessarily require the particular order shown, or sequential order, to achieve desirable results. In some cases, multitasking and parallel processing may be advantageous.

What is claimed is:

1. A method comprising:
receiving a network input; and
processing the network input using a neural network to generate an output for the network input for a machine learning task, wherein:
the neural network comprises a plurality of neural network layers each having a respective activation function, and
the respective activation function for at least one of the layers is a piecewise linear activation function that has one or more parameters that have been learned during training of the neural network on the machine learning task.

2. The method of claim 1, wherein each piecewise linear activation function is a sum of ReLU functions, each ReLU function having a respective anchor value and a respective slope value.

3. The method of claim 2, wherein the respective anchor values and the respective slope values have been learned during the training of the neural network on the machine learning task.

4. The method of claim 2, wherein, prior to training the neural network on the machine learning task, the respective anchor values and the respective slope values have been initialized using a reference activation function.

5. The method of claim 4, wherein initializing the respective anchor values and the respective slope values comprises performing a least-squares minimization to identify the respective anchor values and the respective slope values that minimizes an error between outputs of the piecewise linear activation function and the reference activation function for a set of evaluation points.

6. The method of claim 4, wherein initializing the respective anchor values and the respective slope values comprises obtaining a set of evaluation points and determining, through an iterative procedure, performing a least-squares minimization to identify the respective anchor values and the respective slope values that minimizes an error between outputs of the piecewise linear activation function and the reference activation function for a set of evaluation points.

7. A method for training a neural network to perform a multi-class classification task that requires classifying each received input into one or more classes from a set of classes, wherein the neural network has a plurality of network parameters, and wherein the neural network is configured to process each received input in accordance with the network parameters to generate, for each received input, a respective logit vector that comprises a respective logit for each class in the set of classes, the method comprising repeatedly performing training operations comprising:
obtaining a batch comprising one or more training inputs and a respective label for each training input;
for each training input in the batch:
processing the training input using the neural network and in accordance with current values of the network parameters to generate a respective logit vector for the training input:
generating a link vector that includes a respective score for each class, comprising, for each class, applying a constrained learned link function for the class to the respective logit for the class in the respective logit vector for the training input to generate the respective score for the class;
determining, using the link vector and the label, a gradient with respect to the respective logit vector;
determining, from the gradient with respect to the respective logit vector, a gradient with respect to the network parameters through backpropagation; and
updating the current values of the network parameters using the gradients with respect to the network parameters for the training inputs in the batch.

8. The method of claim 7, further comprising:
updating the constrained learned link function using, for each training input in the batch, the link vector for the training input and the label for the training input.

9. The method of claim 7, wherein the constrained learned link function for the class is a piecewise linear function that is a sum of a plurality of activation functions each having one or more parameters that are adjusted to update the constrained learned link function.

10. The method of claim 9, wherein the constrained learned link function is a sum of reverse-ReLU functions.

11. The method of claim 10, wherein each reverse-ReLU function has a respective anchor value and a respective slope value.

12. The method of claim 11, wherein the respective anchor values and the respective slope values are learned during the training of the neural network.

13. The method of claim 7, wherein:
the neural network comprises a plurality of neural network layers each having a respective activation function, and
the respective activation function for at least one of the layers is a piecewise linear activation function that has one or more parameters that are updated as part of updating the network parameters during the training of the neural network.

14. The method of claim 13, wherein each piecewise linear activation function is a sum of ReLU functions, each ReLU function having a respective anchor value and a respective slope value.

15. The method of claim 14, wherein the respective anchor values and the respective slope values are updated during the training of the neural network.

16. The method of claim 14, wherein, prior to training the neural network, the respective anchor values and the respective slope values have been initialized using a reference activation function.

17. The method of claim 16, wherein initializing the respective anchor values and the respective slope values comprises performing a least-squares minimization to identify the respective anchor values and the respective slope values that minimizes an error between outputs of the piecewise linear activation function and the reference activation function for a set of evaluation points.

18. The method of claim 16, wherein initializing the respective anchor values and the respective slope values comprises obtaining a set of evaluation points and determining, through an iterative procedure, performing a least-squares minimization to identify the respective anchor values and the respective slope values that minimizes an error between outputs of the piecewise linear activation function and the reference activation function for a set of evaluation points.

19. A system comprising one or more computers and one or more storage devices storing instructions that are operable, when executed by the one or more computers, to cause the one or more computers to perform operations comprising:
receiving a network input; and
processing the network input using a neural network to generate an output for the network input for a machine learning task, wherein:
the neural network comprises a plurality of neural network layers each having a respective activation function, and
the respective activation function for at least one of the layers is a piecewise linear activation function that has one or more parameters that have been learned during training of the neural network on the machine learning task.

20. The system of claim 19, wherein each piecewise linear activation function is a sum of ReLU functions, each ReLU function having a respective anchor value and a respective slope value.
